(19) United States
(12) Patent Application Publication
(10) Pub. No.: US 2008/0161072 A1
(43) Pub. Date: Jul. 3, 2008

(54) Methods and apparatus to manage power consumption in wireless devices

(76) Inventors: David Alson Lide, Rockville, MD (US); Praphul Chandra, New Delhi (IN)

Correspondence Address: TEXAS INSTRUMENTS INCORPORATED, P O BOX 655474, M/S 3999, DALLAS, TX, 75265, US

(21) Appl. No.: 11/648,733

(22) Filed: Dec. 29, 2006

(51) Int. Cl. H04M 1/00

(52) U.S. Cl. 455/574

(57) ABSTRACT

Methods and apparatus to manage power consumption in wireless devices are disclosed. A disclosed example apparatus comprises a motion detector to detect motion, and a wireless modem to perform a background scan when motion is detected.

### FIELD OF THE DISCLOSURE

This disclosure relates generally to wireless devices and, more particularly, to methods and apparatus to manage power consumption in wireless devices.

### BACKGROUND

As a wireless device is moved, it performs background scanning in an attempt to maintain communicative coupling with at least one access point. An example wireless device is implemented in accordance with the Institute of Electrical and Electronics Engineers (IEEE) 802.11x family of standards. Background scanning is used to identify one or more additional access points having, for example, an available signal and/or a signal having a better signal quality and/or strength. For example, as the wireless device moves, the signal quality and/or strength associated with a current access point may degrade while the signal quality and/or strength associated with another access point improves. When either of the degradation and/or the improvement is sufficient, the wireless device terminates its communication with the current access point and initiates communication with the other access point.

### BRIEF DESCRIPTION OF THE DRAWINGS

FIG. 1 is a diagram of an example wireless network that includes a wireless device constructed in accordance with the teachings of the invention.

FIG. 2 illustrates an example manner of implementing the example wireless device of FIG. 1.

FIG. 3 illustrates an example manner of implementing the example scanning module of FIG. 2.

FIG. 4 is a flowchart representative of example machine accessible instructions that may be executed to implement the example scanning module of FIGS. 2 and/or 3 and/or, more generally, the example wireless device of FIGS. 1 and 2.

### DETAILED DESCRIPTION

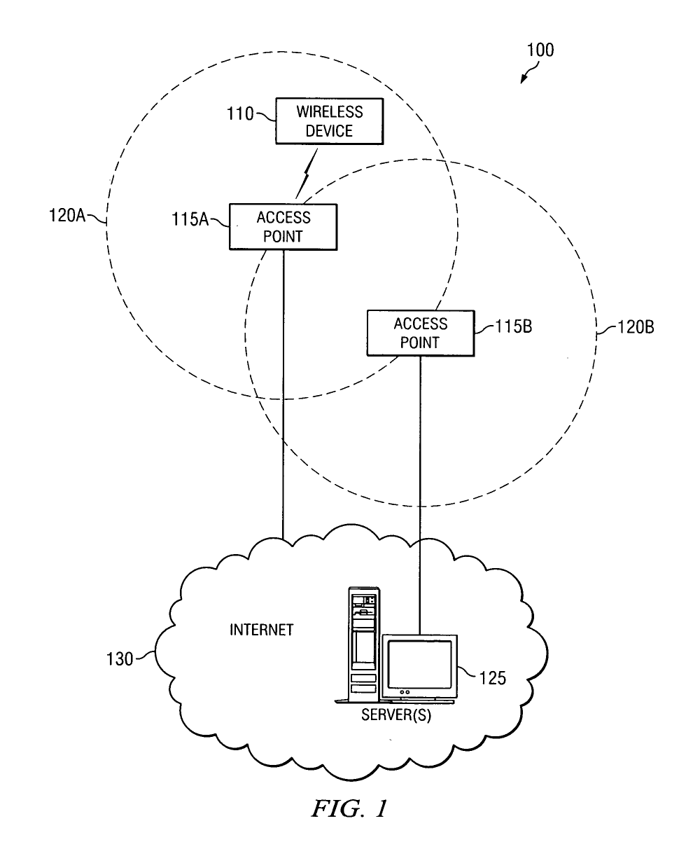

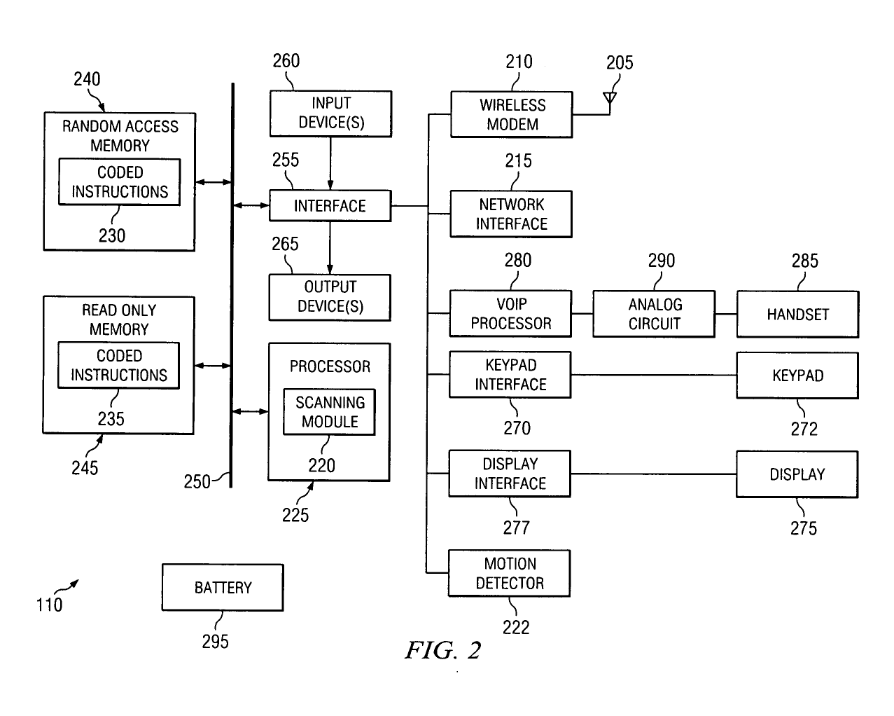

FIG. 1 illustrates an example wireless network 100 that includes any number and/or type(s) of fixed-location, substantially fixed-location and/or mobile wireless devices, one of which is respectively designated in FIG. 1 with reference numeral 110. Example mobile wireless devices 110 include a personal digital assistant (PDA), an MP3 player such as an iPod®, a wireless telephone (e.g., a cellular phone, a voice over Internet Protocol (VoIP) phone, a smart phone, etc.), a laptop computer with wireless communication capabilities, etc. Example fixed-location or substantially fixed-location wireless devices 110 include, for example, a desktop personal computer (PC) with wireless communication capabilities. An example manner of implementing an example wireless device 110 is described below in connection with FIG. 2.

To provide wireless data and/or communication services (e.g., telephone services, Internet services, data services, messaging services, instant messaging services, electronic mail (email) services, chat services, video services, audio services, gaming services, etc.) over a site, location, building, geographic area and/or geographic region, the example wireless network 100 of FIG. 1 includes any number and/or type(s) of access points, two of which are illustrated in FIG. 1 with reference numbers 115A and 115B. For example, the example access points 115A, 115B of FIG. 1 could be arranged in a pattern and/or grid with abutting and/or overlapping coverage areas 120A, 120B such that the wireless device 110 located in, and/or moving through and/or within an area communicatively covered by the access points 115A, 115B, the wireless device 110 can communicate with at least one of the access points 115A, 115B.

The example wireless device 110 and/or the example access points 115A, 115B of FIG. 1 are implemented in accordance with one or more past, present and/or future wired and/or wireless communication standards and/or specifications (e.g., one or more past, present and/or future standards from the Institute of Electrical and Electronics Engineers (IEEE) 802.11x family of standards) and/or implement features from one or more of those standards and/or specifications. Moreover, the example wireless device 110 and/or any of the example access points 115A, 115B may implement a similar and/or a different set, subset and/or combination of the IEEE 802.11x standards.

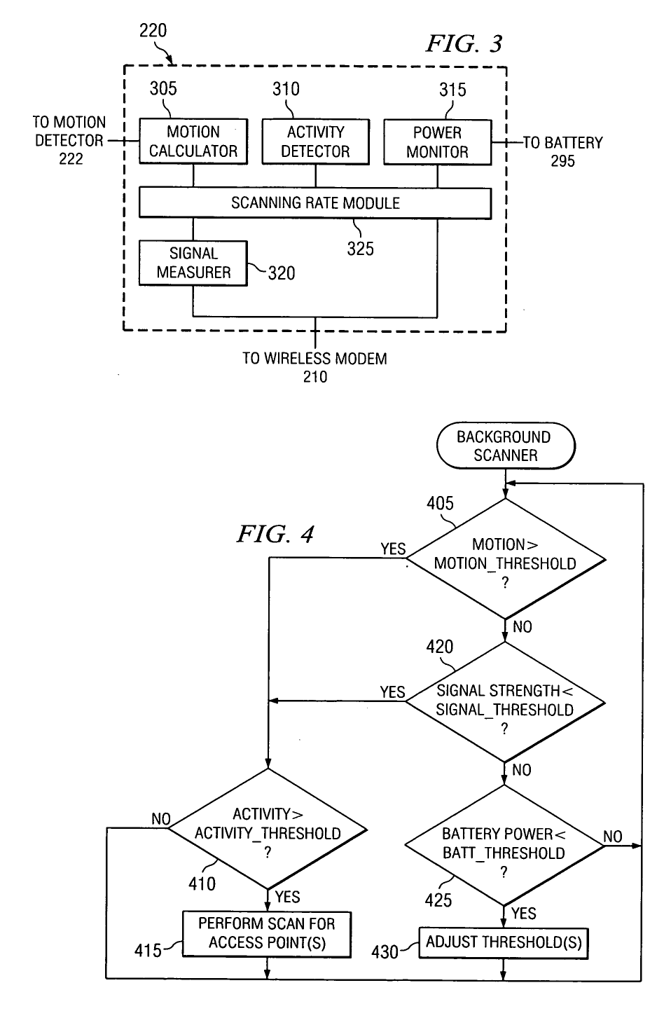

Depending upon the current location of the example wireless device 110, the wireless device 110 will receive a stronger and/or higher quality signal from one of the access points 115A, 115B than from the other(s) of the access points 115A, 115B based upon its proximity and/or distance to each of the access points 115A, 115B. The signal strengths and/or signal qualities may also be affected by, for example, interference, noise, and/or reflections of wireless signals by intervening objects. The signal strength and/or signal quality associated with a particular access point 115A, 115B may change as the wireless device 110 moves through and/or within an area 120A, 120B covered by the access point 115A, 115B. As such, the example wireless device 110 of FIG. 1 performs background scanning and/or signal monitoring to identify other access points 115A, 115B that may provide a stronger and/or higher quality signal. Because background scanning consumes battery power, the example wireless device 110 of FIG. 1 includes any type of motion detector 222 that enables the example wireless device 110 to determine whether the wireless device 110 is currently moving. Example motion detectors 222 include, but are not limited to, an accelerometer (e.g., the ADXL202E tilt/motion sensor from Analog Devices, Inc.), a rocker switch, a vibration detector, a satellite positioning system receiver (e.g., in accordance with the global positioning system GPS), a gyroscope, and/or a camera used to capture images that are processed to detect motion. However, any other type(s) of motion detector 222 could be used. When the motion detector 222 indicates that the wireless device 110 is not moving, the wireless device 110 conserves battery power by not performing background scanning. As described below in connection with FIG. 3, the example wireless device 110 may also use one or more of a signal strength, a remaining battery power and/or an activity detector to determine whether and/or when the wireless device 110 performs background scanning.

In the example system 100 of FIG. 1, to allow the wireless device 110 to communicate with devices and/or servers, the example access points 115A, 115B are communicatively coupled via any type(s) of communication paths to, for example, any number and/or type(s) of server(s) 125 associated with one or more public and/or private Internet Protocol (IP) based network(s) such as the Internet 130. The example server(s) 125 may be used to implement access control and/or to provide, receive and/or deliver, for example, any number and/or type(s) of data, video, audio, telephone, gaming, Internet, messaging and/or electronic mail services.

While this disclosure refers to the example wireless network 100 of FIG. 1, the example wireless device 110 and/or the example access points 115A, 115B of FIG. 1, the example wireless network 100 of FIG. 1 may be used to provide services to, from and/or between any alternative and/or additional wired and/or wireless communication devices (e.g., telephone devices, personal digital assistants (PDA), laptops, etc.). Additionally, although for purposes of explanation, the descriptions contained herein refer to the example wireless network 100, the example wireless device 110 and/or the example access points 115A, 115B illustrated in FIG. 1, any additional and/or alternative type and/or number of communication systems, communication devices and/or communication paths may be used to implement a wireless network and/or to provide data and/or communication services. Moreover, while these descriptions reference the IEEE 802.11x family of standards, persons of ordinary skill in the art will appreciated that the methods and apparatus disclosed herein may be utilized for wireless networks operated in accordance with any past, present and/or future standards and/or specifications such as, for example, the IEEE 802.16x (a.k.a. WiMax) family of standards.

FIG. 2 illustrates an example manner of implementing the example wireless device 110 of FIG. 1. To implement wireless communications with the example access points 115A, 115B and/or one or more other wireless devices of the example wireless network 100 of FIG. 1, the example wireless device 110 of FIG. 2 includes any number and/or type(s) of radio frequency (RF) antennas 205 and any number and/or type(s) of wireless modems 210. The example RF antenna 205 and the example wireless modem 210 of FIG. 2 are able to receive, demodulate and decode WLAN, WiFi and/or WiMax signals transmitted to and/or within the example wireless network 100 of FIG. 1. Likewise, the wireless modem 210 and the RF antenna 205 are able to encode, modulate and transmit WLAN, WiFi and/or WiMax signals from the example wireless device 110 to any or all of the example access points 115A, 115B and/or the example wireless device(s) 110 of the example wireless network 100 of FIG. 1. Thus, as commonly referred to in the industry, the example RF antenna 205 and the example wireless modem 210 collectively implement the physical layer (a.k.a. PHY) for the example wireless device 110 of FIG. 2.

To communicatively couple the example wireless device 110 of FIG. 2 to another device and/or network (e.g., a local area network (LAN), a modem, a router, a bridge and/or a gateway), the example wireless device 110 of FIG. 2 includes any number and/or type(s) of network interfaces 215. However, a wireless device 110 need not include a network interface 215. The example network interface 215 of FIG. 2 operates in accordance with any of the IEEE 802.3x (a.k.a. Ethernet) family of standards.

As described above in conjunction with FIG. 1, the wireless device 110 may at any particular time have a geographic location such that the wireless device 110 has a better signal quality and/or signal strength when communicating with a particular one of the access points 115A, 115B. Moreover, as the wireless device 110 moves, the access point (115A or 115B) providing the best signal quality and/or highest signal strength may change. To manage and/or control bandwidth scanning, the example wireless device 110 of FIG. 2 includes a scanning module 220 and any type of motion detectors(s) 222. Using any algorithm(s), logic(s), method(s) and/or circuit(s), the example motion detector 222 of FIG. 2 monitors and/or detects the motion of the wireless device 110, and provides one or more outputs and/or values representative and/or characteristic of the detected motion. The example scanning module 220 of FIG. 2 determines when to perform background scanning to attempt to identify and/or locate an access point 115A, 115B that provides a better signal quality and/or signal strength based upon one or more parameter(s), input(s) and/or value(s), such as the output(s) and/or value(s) provided by the motion detector 222. An example manner of implementing the example scanning module 220 of FIG. 2 is described below in connection with FIG. 3.

To implement the example scanning module 220 using one or more of any number and/or type(s) of software, firmware, processing thread(s) and/or subroutine(s), the example wireless device 110 of FIG. 2 includes a processor 225. The example processor 225 of FIG. 2 may be and/or include one or more of any type(s) of processors such as, for example, a microprocessor, a processor core, a microcontroller, a digital signal processor (DSP), an advanced reduced instruction set computing (RISC) machine (ARM) processor, etc. The example processor 225 executes coded instructions 230 and/or 235 which may be present in a main memory of FIG. 2 (e.g., within a random-access memory (RAM) 240 and/or a read-only memory (ROM) 245) and/or within an on-board memory of the processor 225. The example processor 225 may execute, among other things, the example machine accessible instructions illustrated in FIG. 4 to implement the example scanning module 220.

While in the illustrated example of FIG. 2, the example scanning module 220 is implemented by executing one or more type(s) of software, firmware, processing thread(s) and/or subroutine(s) with the example processor 225, the example scanning module 220 of FIG. 2 may be, additionally or alternatively, implemented using any number and/or type(s) of application specific integrated circuit(s) (ASIC(s)), programmable logic device(s) (PLD(s)), field programmable logic device(s) (FPLD(s)), discrete logic, hardware, firmware, etc. Also, some or all of the example scanning module 220 may be implemented manually or as any combination of any of the foregoing techniques. For example, the scanning module 220 may be implemented by any combination of firmware, software and/or hardware.

The example processor 225 of FIG. 2 is in communication with the main memory (e.g., the RAM 240 and/or the ROM 245) via a bus 250. The example RAM 240 may be implemented by DRAM, SDRAM, and/or any other type of RAM device. The example ROM 245 may be implemented by flash memory and/or any other desired type of memory device. Access to the memories 240 and 245 is typically controlled by a memory controller (not shown). The RAM 240 may be used, for example, to store one or more thresholds which are used to determine whether and/or when to perform background scanning.

The example wireless device 110 of FIG. 2 also includes any number and/or type(s) of interface circuits 255. The example interface circuit 255 of FIG. 2 may implement any number and/or type(s) of interfaces, such as external memory interface(s), serial port(s), general purpose input/output port(s), etc. Additionally or alternatively, the interface circuit 255 may communicatively couple the example wireless modem 210 and/or the network interface 215 with the processor 225 and/or the example scanning module 220.

In the example of FIG. 2, any number and/or type(s) of input devices 260 and any number and/or type(s) of output devices 265 are connected to the interface circuit 255. To facilitate user inputs via any type of keypad 250, the example wireless device 110 of FIG. 2 includes any type of keypad interface 270. The example keypad interface 270 of FIG. 2 electrically couples and/or translates electrical signals conveying key press information from the example keypad 172 to the example processor 225.

To provide output information to a user via any number and/or type(s) of displays 275, the example wireless device 110 of FIG. 2 includes any number and/or type(s) of display interfaces 277. An example display interface 277 receives information (e.g., alphanumeric characters) to be displayed from the example processor 225 and creates electrical signals suitable for displaying the information on the example display 275. An example display 275 is a liquid-crystal display (LCD) screen.

To implement voice over IP (VoIP) services, the example wireless device 110 of FIG. 2 includes a VoIP processor 280. However, a wireless device 110 need not include a VoIP processor 280. The example VoIP processor 280 of FIG. 2 implements, among other things, session control, VoIP protocols, a SIP user agent, and a coder (not shown) to encode audio and/or video signals, a decoder (not shown) to decode received audio and/or video signals, a packetizer (not shown) to packetize encoded data and a de-packetizer (not shown) to de-packetize encoded data.

To electrically couple signals (e.g., speech signals) between a handset 285 and the example VoIP processor 280, the example wireless device 110 of FIG. 2 includes any number and/or type(s) of analog circuits 290. An example analog circuit 290 includes any number and/or type(s) of filter(s), analog-to-digital converter(s) and/or digital-to-analog converter(s) to convert between analog signals sent to and/or received from an example handset 285 and digital signals sent to and/or received from the example VoIP processor 280. The handset 285 can be corded or cordless.

To this end, the example analog circuit 290 of FIG. 2 may implement any number and/or type(s) of wireless communication technologies to communicatively couple the example VoIP processor 280 with any type of cordless handset 285. Moreover, the example analog circuit 290 of FIG. 2 may, additionally or alternatively, implement any number and/or type(s) of subscriber line interface circuits (SLICs) that allow any number and/or type(s) of corded and/or cordless PSTN-based telephones (not shown) to be electrically coupled to the example VoIP processor 280 of FIG. 2. The latter example could be used, for instance, in implementations where the example wireless device 110 is located in and/or implements a VoIP analog telephone adapter (ATA) and/or a VoIP residential gateway.

To provide power, the example wireless device 110 of FIG. 2 includes any type of power supply, such as any type(s) of battery(-ies) 295, alternating current (AC) to direct current (DC) converter(s), and/or a DC-to-DC converter(s).

While an example manner of implementing the example wireless device 110 of FIG. 1 is illustrated in FIG. 2, a wireless device 110 may be implemented using any number and/or type(s) of other and/or additional element(s), processor(s), device(s), component(s), circuit(s), module(s), interface(s), etc. Further, the element(s), processor(s), device(s), component(s), circuit(s), module(s), element(s), interface(s), etc. illustrated in FIG. 2 may be combined, divided, re-arranged, eliminated and/or implemented in other ways. For example, the wireless modem 210 may implement all or a portion of the example scanning module 220. Additionally, the example interface 255, the example wireless modem 210, the example network interface 215, the example scanning module 220, the example motion detector 222, the example VoIP processor 280 and/or, more generally, the example wireless device 110 of FIG. 2 may be implemented as any combination of firmware, software, logic and/or hardware. Moreover, the example wireless device 110 may include additional processor(s), device(s), component(s), circuit(s), interface(s) and/or module(s) than those illustrated in FIG. 2 and/or may include more than one of any or all of the illustrated processor(s), device(s), component(s), circuit(s), interface(s) and/or module(s).

FIG. 3 illustrates an example manner of implementing the example scanning module 220 of FIG. 2. To detect, determine, estimate and/or calculate an amount of motion, the example scanning module 220 of FIG. 3 includes a motion calculator 305. Using any algorithm(s), method(s), logic and/or circuit(s) and based upon outputs and/or values from an motion detector (e.g., the example motion detector 222 of FIG. 2), the example motion calculator 305 of FIG. 3 computes one or more parameters and/or values that represent and/or characterize the motion of a wireless device (e.g., the example wireless device 110 of FIGS. 1 and/or 2). For example, the motion calculator 305 can apply a filter and/or smoothing operation to outputs and/or values received from the motion detector to remove unwanted artifacts and/or noise, such as that created by a wireless device that is moving slightly but staying in substantially the same location.

To detect usage of the wireless device by a user and/or communicatively coupled device, the example scanning module 220 of FIG. 3 includes an activity detector 310. The example activity detector 310 of FIG. 3 may detect usage by, for example, detecting any type of data associated with any number and/or type(s) of usages such as, for example, viewing of a website, a data transfer, sending email, receiving email, sending messages, receiving messages, gaming, and/or a telephone conversations. The example activity detector 310 uses the detection of usage(s) to determine and/or calculate one or more values and/or parameters that characterize and/or represent current usage of the wireless device. For example, when the wireless device is not currently being used over a particular period of time, a value calculated by the activity detector 310 will be less than a threshold.

To monitor remaining battery power, the example scanning module 220 of FIG. 3 includes a power monitor 315. Using any algorithm(s), method(s), logic and/or circuit(s), the example power monitor 315 of FIG. 3 monitors and/or estimates the remaining power in a battery (e.g., the example battery 295 of FIG. 2) and calculates one or more values that represent the remaining power. The remaining power may be estimated, for example, by receiving a value representing a remaining charge and/or a current being provided by a battery.

To determine signal quality and/or signal strength, the example scanning module 220 of FIG. 3 includes a signal measurer 320. Using any algorithm(s), method(s), logic and/or circuit(s), the example signal measurer 320 of FIG. 3 measures, calculates and/or estimates the quality and/or strength of a wireless signal received from an access point 115A, 115B. In some examples, the example signal measurer 320 is implemented by and/or as part of a wireless modem (e.g., the example wireless modem 210 of FIG. 2). The signal measurer 320 may measure signal quality by, for example, estimating a signal-to-noise ratio and/or an attenuation associated with a received wireless signal

To determine whether and/or when to perform background scanning, the example scanning module 220 of FIG. 3 includes a scanning rate module 320. The example scanning rate module 325 uses one or more outputs and/or values provided by the example motion calculator 305, the example activity detector 310, the example power monitor 315 and/or the example signal measurer 320 to determine whether and/or how often to perform background scans. For example, when the motion calculator 305 indicates that the wireless device is substantially and/or sufficiently stationary, the example scanning rate module 325 directs the wireless modem 210 to not perform background scanning. When the detected motion indicates that the wireless devices has begun moving, the scanning rate module 320 directs the wireless modem 210 to begin and/or re-start background scanning. Additionally or alternatively, how often background scans are performed (e.g., a background scanning frequency and/or an interval between background scans) could be adjusted based upon an amount of detected motion. For example, as more motion is detected, more background scans could be performed. Example machine accessible instructions that may be executed to implement the example scanning rate module 320 and/or, more generally, the example scanning module 210 are described below in connection with FIG. 4.

While an example manner of implementing the example scanning module 220 of FIG. 2 is illustrated in FIG. 3, the scanning module 220 may be implemented using any number and/or type(s) of other and/or additional element(s), processor(s), device(s), component(s), circuit(s), module(s), interface(s), etc. Further, the element(s), processor(s), device(s), component(s), circuit(s), module(s), element(s), interface(s), etc. illustrated in FIG. 3 may be combined, divided, re-arranged, eliminated and/or implemented in other ways. Additionally, the example motion calculator 305, the example activity detector 310, the example power monitor 315, the example signal measurer 320, the example scanning rate module 325 and/or, more generally, the example scanning module 220 of FIG. 3 may be implemented as any combination of firmware, software, logic and/or hardware. Moreover, the example scanning module 220 may include additional processor(s), device(s), component(s), circuit(s), interface(s) and/or module(s) than those illustrated in FIG. 3 and/or may include more than one of any or all of the illustrated processor(s), device(s), component(s), circuit(s), interface(s) and/or module(s).

FIG. 4 is a flowchart representative of example machine accessible instructions that may be executed to implement the example scanning rate module 320 and/or, more generally, the example scanning module 210 of FIGS. 2 and 3. The example machine accessible instructions of FIG. 4 may be executed by a processor, a controller and/or any other suitable processing device. For example, the example machine accessible instructions of FIG. 4 may be embodied in coded instructions stored on a tangible medium such as a flash memory, a ROM and/or RAM associated with a processor (e.g., the example processor 225 of FIG. 2). Alternatively, some or all of the example flowchart of FIG. 4 may be implemented using any combination(s) of ASIC(s), PLD(s), FPLD(s), discrete logic, hardware, firmware, etc. Also, some or all of the example flowchart of FIG. 4 may be implemented manually or as any combination(s) of any of the foregoing techniques, for example, any combination of firmware, software, discrete logic and/or hardware. Further, although the example machine accessible instructions of FIG. 4 are described with reference to the flowchart of FIG. 4, persons of ordinary skill in the art will readily appreciate that many other methods of implementing the example scanning rate module 320 and/or, more generally, the example scanning module 210 of FIGS. 2 and 3 may be employed. For example, the order of execution of the blocks may be changed, and/or some of the blocks described may be changed, eliminated, sub-divided, or combined. Additionally, persons of ordinary skill in the art will appreciate that the example machine accessible instructions of FIG. 4 may be carried out sequentially and/or carried out in parallel by, for example, separate processing threads, processors, devices, discrete logic, circuits, etc.

The example machine accessible instructions of FIG. 4 begin with a scanning module (e.g., the example scanning rate module 210 of FIGS. 2 and/or 3) determining if a detected amount of motion exceeds a motion threshold (block 405). For example, the scanning module determines if the wireless device has moved sufficiently such that background scanning is warranted.

If the detected amount of motion exceeds the motion threshold (block 405), the scanning module determines if a detected amount of usage and/or usage activity exceeds an activity threshold (block 410). For example, the scanning module determines if the wireless device is currently being used by a user or if the wireless device is substantially idle. If the amount of usage exceeds the activity threshold (block 410), the scanning module directs, instructs a wireless modem (e.g., the example wireless modem 210 of FIG. 2) to begin and/or continue performing background scanning (block 415). Control then returns to block 405.

If the detected amount of motion does not exceed the motion threshold (block 405), the scanning module determines if the signal strength and/or quality is less than a signal threshold (block 420). Such a condition may arise when the wireless device is positioned such that the signal strength and/or quality to a current access point has degraded due to, for example, movement, equipment failure, interference and/or reflections. If the signal strength and/or quality has sufficiently degraded (block 420), the scanning module directs, instructs the wireless modem (e.g., the example wireless modem 210 of FIG. 2) to begin and/or continue performing background scanning (block 415). Control then returns to block 405.

If the signal strength and/or quality is not less than the signal threshold (block 420), the scanning module checks the remaining power of the battery (block 425). If the remaining power is less than a battery threshold (block 425), the scanning module adjusts one or more of the motion threshold, the activity threshold and/or the signal threshold to reduce how often background scanning is performed (block 430). For example, the scanning module increases the motion threshold such that more motion is required before background scanning is performed. Control then returns to block 405.

If the remaining power is not less than the battery threshold (block 425), control returns to block 405 without adjusting any of the thresholds.

Persons of ordinary skill in the art will appreciate that some or all of the blocks of FIG. 4 may be eliminated if desired. For example, block 410 may be eliminated if the activity detector 310 of FIG. 4 is not included. Persons of ordinary skill in the art will also appreciate that the example background scanning on/off decisions made at blocks 405, 410 and 420 could be modified and/or enhanced such that the background scanning frequency is adjusted and/or determined based upon the amount of detected motion, the amount of detected activity and/or the signal strength/quality. Moreover, any combination(s) of logic could be used to control background scanning rates. For example, for detected motion below a threshold, no background scans are performed, while for detected motion above the threshold, the frequency of background scanning increases as the detected motion increases.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An apparatus comprising:
a motion detector to detect motion; and
a wireless modem to perform a background scan when motion is detected.

2. An apparatus as defined in claim 1, wherein the wireless modem is implemented in accordance with a standard from the Institute of Electrical and Electronics Engineer (IEEE) 802.11x family of standards.

3. An apparatus as defined in claim 1, wherein the motion detector is an accelerometer.

4. An apparatus as defined in claim 1, further comprising a scanning module to determine when to perform the background scan based upon the detected motion.

5. An apparatus as defined in claim 4, wherein the scanning module comprises:
a motion calculator to determine a first value representative of the detected motion; and
a scanning rate module to compare the first value to a threshold.

6. An apparatus as defined in claim 5, wherein the scanning module further comprises a power monitor to determine a second value representative of a remaining battery power, the scanning rate module to adjust the threshold based upon the second value.

7. An apparatus as defined in claim 4, wherein the scanning module comprises an activity detector to determine a value representative of usage, the wireless modem to perform the background scan based upon the detected motion and the value.

8. An apparatus as defined in claim 4, wherein the scanning module comprises a signal measurer to determine a value representative of a signal strength, the wireless modem to perform the background scan when the value is less than a threshold.

9. An apparatus as defined in claim 1, wherein a background scanning frequency is adjusted based upon a value representative of the detected motion.

10. An apparatus as defined in claim 1, wherein the apparatus is at least one of a personal digital assistant (PDA), an MP3 player, a wireless telephone, a cellular phone, a voice over Internet Protocol (VoIP) phone, a smart phone, or a computer.

11. A method comprising:
detecting motion of a wireless device; and
controlling a background scan based upon the detected motion.

12. A method as defined in claim 11, wherein the background scan is performed in accordance with a standard from the Institute of Electrical and Electronics Engineer (IEEE) 802.11x family of standards.

13. A method as defined in claim 11 wherein controlling the background scan comprises:
determining a first value representative of the motion; and
comparing the first value to a threshold.

14. A method as defined in claim 13, wherein an interval between the background scan and a second background scan is reduced when the first value is greater than the threshold.

15. A method as defined in claim 13, further comprising:
determining a second value representative of a battery strength; and
adjusting the threshold based upon the second value.

16. A method as defined in claim 11, further comprising:
determining a strength of a received signal; and
performing the background scan when the strength is less than a threshold.

17. A method as defined in claim 11, further comprising:
determining a value representative of a usage; and
repressing the background scan when the value is less than a threshold.

18. An article of manufacture storing machine accessible instructions which, when executed, cause a machine to:
detect motion of a wireless device; and
control a background scan based upon the detected motion.

19. An article of manufacture as defined in claim 18, wherein the machine accessible instructions, when executed, cause the machine to control the background scan by:
determining a first value representative of the motion; and
comparing the first value to a threshold.

20. An article of manufacture as defined in claim 19, wherein the machine accessible instructions, when executed, cause the machine to perform the background scan when the first value is greater than the threshold.

21. An article of manufacture as defined in claim 18, wherein the machine accessible instructions, when executed, cause the machine to:
determine a strength of a received signal; and
perform the background scan when the strength is less than a threshold.

22. An article of manufacture as defined in claim 18, wherein the machine accessible instructions, when executed, cause the machine to:
determine a value representative of a usage; and
repress the background scan when the value is less than a threshold.
